(19) United States
(12) Patent Application Publication
(10) Pub. No.: US 2022/0357766 A1
(43) Pub. Date: Nov. 10, 2022

(54) MOBILE INDIVIDUAL SECURE COMMUNICATIONS ENVIRONMENT

(71) Applicant: Anjuma KARKERA, McLean, VA (US)

(72) Inventor: Anjuma KARKERA, McLean, VA (US)

(21) Appl. No.: 17/740,141

(22) Filed: May 9, 2022

Related U.S. Application Data
(60) Provisional application No. 63/186,482, filed on May 10, 2021.
(60) Provisional application No. 63/332,078, filed on Apr. 18, 2022.

(51) Int. Cl. G06F 1/16; G06F 3/16; G06F 21/60; G02B 27/01

(52) U.S. Cl. CPC G06F 1/163; G06F 3/167; G06F 21/606; G02B 27/017; G06F 1/1681; G02B 2027/0178

(57) ABSTRACT

Various embodiments include a mobile confidential and secure communication environment for enabling a user to engage in secure video and audio communications. Various embodiments may include a headset, eyewear that includes a display that is configured to display images for viewing by the user while preventing such imagery to be viewed by others, headphones configured to provide audio to the user while preventing sounds from being overheard by other, a mouthpiece including a microphone configured to receive speech spoken by the user while preventing such speech from being overheard by others, and a secure communication interface configured to provide a secure communication link to a mobile device or desktop computer for communicating sound data to the headphones and sound data from the mouthpiece and communicating image data to the eyewear. Various embodiments may fully integrate sight and voice through technical capabilities to enable a confidential and private communications environment.

### RELATED APPLICATIONS

This non-provisional application claims the benefit of priority to U.S. Provisional Application No. 63/186,482 entitled “MOBILE INDIVIDUAL SECURE COMMUNICATIONS ENVIRONMENT” filed May 10, 2021, and to U.S. Provisional Application No. 63/332,078 entitled “MOBILE INDIVIDUAL SECURE COMMUNICATIONS ENVIRONMENT” filed Apr. 18, 2022, the entire contents of both of which are hereby incorporated by reference for all purposes.

### BACKGROUND

In many corporate, academic, military and government settings, the ability to communicate outside of a facility is restricted by the inability to secure information against electronic surveillance and data leakage. On an individual level, there is a demand to have private communications regardless of location. With an increased desire to be more mobile not tethered to a location and a business requirement to successfully recruit from the global talent, there is a need for a mobile individual secure communications environment integrating the ability to secure sight, sound and speech.

In order to remove physical co-location and effectively operate, there are three communication elements that must be integrated to creating a secure, synchronized capability. The first is visual capability that allows the individual user to see information without exposing it to the sight of others. The second is audio capability that allows the user to hear information without others being able to hear it. And, the third is the voice that allows the user to speak freely without others having access to what is being said. The key is to integrate and synchronize all three of these capabilities to create a single multifunctional and all-encompassing individual mobile secure communications environment. By eliminating or mitigating working from a specific location or, in other words, operating securely regardless of location, it enhances business continuity, continuity of government, addressing emergency situations (e.g. weather events, pandemics, and national emergencies), and evolving the understanding of “going to work”.

Today, there are several ways in which organizations meet the challenge of security, confidentiality and privacy in an attempt to mitigate the requirement of physical co-location. In all cases, a secure room, even for an individual, is required to prevent unauthorized electronic surveillance and data leakage. In the case of the Department of Defense, they use a Sensitive Compartmented Information Facility (SCIF) which is a term for a secure room that is a certified structure to guard against electronic surveillance and data leakage. It also prevents access by unauthorized people for purposes of protecting confidential and secure material. A SCIF requires physical security, acoustic protections, visual controls, mechanical/electrical/plumbing (MEP) systems, electronic access control systems (ACS), intrusion detection and electromagnetic shielding (RF shielding). There are “mobile” SCIFs available which are SCIFs on wheels and don't readily afford individual mobility.

In addition, corporate and academic organizations require that access-controlled information (e.g. confidential, trademark, copyright, or formula-based content) be viewed in a secure environment which may involve a monitored room. The limitations and restrictions are largely based on the inability to secure and protect the information from unauthorized viewing and hearing of the information.

Everyone has an interest, at times, in keeping their conversations, and mobile device screens private. So, they cover their mouth and shield their device screens with their hand and use forms of noise cancelling headphones to block out sound they do not want to share or hear. While existing capabilities address some of the concerns individually, no existing capability addresses the ability to secure sight, hearing and voice in a single device.

### SUMMARY

Various embodiments described herein include methods and devices for providing a mobile confidential and secure communication environment by integrating and augmenting technical capability which may negate or limit the need for a facility and minimizes the lack of communication privacy in many settings. Various embodiments integrate a sound cancelling mouthpiece and earpiece and a virtual smart eyewear that have the ability to make any monitor or screen invisible to anybody other than the user of the eyewear. With the synchronization of these capabilities, the various embodiments create a fully integrated individual, mobile, secure, and confidential communication environment.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a diagram illustrating major components of an example embodiment.

FIG. 2 is a software block diagram illustrating software modules and subsystems of an example embodiment.

FIG. 3 is a hardware block diagram illustrating hardware components and subsystems of an example embodiment.

FIGS. 4A-4C are diagrams illustrating major components of a first alternative example embodiment.

FIG. 5 is a diagram illustrating selected components of the first alternative example embodiment.

FIG. 6A and 6B are diagrams illustrating major components of a second alternative example embodiment.

FIG. 7 is a diagram illustrating the second alternative example embodiment being worn by a user.

FIGS. 8A-8C are diagrams illustrating major components of a third alternative example embodiment.

### DETAILED DESCRIPTION

Various embodiments may utilize a microcontroller (MCU) based device which can be connected to any mobile devices (phone, laptop, or table) or desktop computers. This device may utilize an intelligent firmware that can be upgraded on site or over a network. The device may have memory storage and decision making capabilities.

The mobile confidential and secure communication environment according to various embodiments may include virtual smart eyewear: The purpose of the eyewear is to make all information visible exclusively to the user. The eyewear may integrate with any mobile devices (phone, laptop, or table) or desktop to virtually display the information to the user and make it shielded to anybody other than the user of the eyewear. Through a secure connection to a mobile device, the eyewear can also be connected to a secure virtual machine (e.g. Citrix®) to provide a unique virtual operating system and desktop.

The mobile confidential and secure communication environment is configured to prevent those that are not intended to have access to the information that is being provided through sight, voice and audio capability. In other words, the device according to various embodiments will enable only those that are the intended recipient of information to hear and see the information. A user must have an electronic device (e.g., a smart phone, laptop computer, desktop computer, secure telephone, etc.) that contains protected information or has the ability to access it through appropriate software allows access to information (e.g. Citrix or any cloud based application). The device according to various embodiments may be connected to the user's electronic device, and the user may be authenticated through one or more multi-factor authentication methods (e.g. retinal, finger print, multifactor sign in) as well as sensors on the device to ensure continuous secure wearing of the device. When the device is turned on, communications between the device and the connected electronic device will result in the connected electronic device discontinuing output on the display and speakers, and routing images and sound to the device according to various embodiments. A user wearing the device according to various embodiments will then have access to the information as long as the device is continuously and securely worn by the user. If the device is removed by the user or disconnected from its sensors that ensure proper secure wearing, the information will longer be shared (visible or heard) through the device.

In some embodiments, the user may be able to engage portions of the integrated mobile confidential and secure communication environment according to various embodiments. For example, if the information is only visible (i.e., images or video presented on the eyewear was France's, the user would not have to engage or use the audio and voice capabilities. The ability to use various portions of the device may enhance the user experience.

The integrated mobile confidential and secure communication environment according to various embodiments may be used in a variety of situations in which the user has a desire or need to receive secure information and reply by voice without the risk of being overheard. For example, the integrated mobile confidential and secure communication environment may be used in intelligence community and other federal government agencies to access classified and/or protected information in a secure manner when outside of a SCIF, such as in a war zone, while performing government related inspections, or while engaged in government related audits. As another example, the integrated mobile confidential and secure communication environment may be useful in the corporate environment, such as to discussion share a variety of proprietary information requires confidences, such as board meetings, financial document reviews, legal or court related proceedings, sensitive inspections, and the like. As a further example, the integrated mobile confidential and secure communication environment may serve a variety of personal uses, such as to help minimize intrusion or disruption while engaging in a personal conversation in a public setting without interruption or eavesdropping by others (e.g., in a crowded environment, on public transportation, etc.).

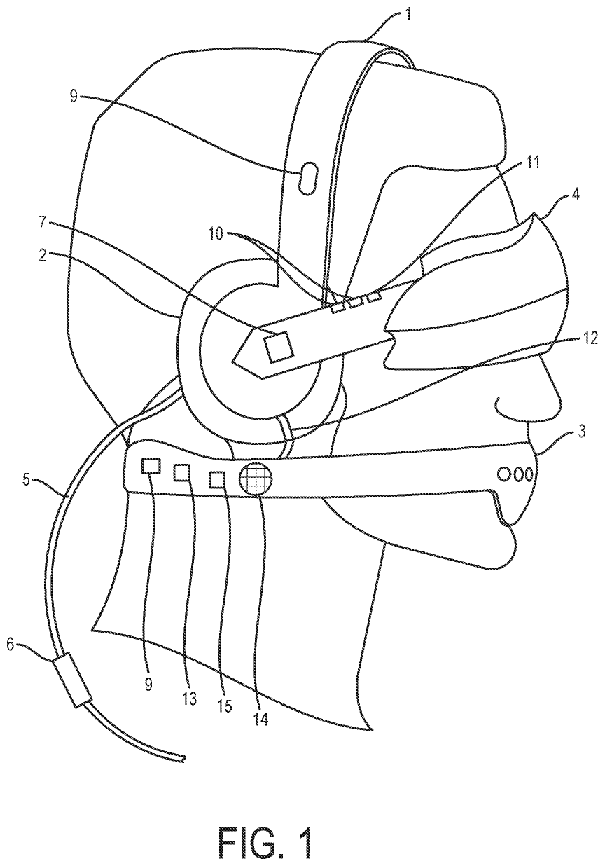

FIG. 1 is a diagram illustrating major components of an example embodiment of an integrated mobile confidential and secure communication environment. With reference to FIG. 1, the integrated mobile confidential and secure communication environment may include a headset 1 that includes or is coupled to headphones 2, a private display in the form of eyewear 4 that allows the information on a mobile device or desktop to be visualized from the user but not others, and a sound canceling mouthpiece 3.

Typically, communication links to the remote service (e.g., Citrix) providing secure information will be encrypted, with decryption of download information and encryption of upload information being performed by secure electronic device coupled to the integrated mobile confidential and secure communication environment headset 1 or other components. To prevent electronic eavesdropping on the information, the headset 1 may include a secure communication interface configured to securely connect to the secure electronic device such as a mobile device (e.g., smart phone, laptop, or tablet) or desktop computer. In some embodiments, the secure communication interface may be a wired connection 5. Any point to point wired connection 5 (e.g., USB; USB-C; HDMI, etc.) carried through shielded cables may be used to enable secure connectivity. The wired connection 5 may be shielded and also include a ferrite choke 6 to reduce any noise, Radio Frequency Interference (RFI) and electromagnetic interference (EMI).

To protect the content from outside view, the eyewear 4 may have a guard or awning (not shown) shielding peripheral sight of information to maintain confidentiality. In some embodiments, the secure communication interface may be a secure wireless communication interface configured to establish and support an encrypted communication link with a mobile device or desktop computer via a wireless communication protocol, such as Bluetooth, WIFI, or other wireless local area network (WLAN) communication link. The eyewear 4 may include a camera (not shown) that may be configured to support retinal, fingerprint and voice recognition and scanning to authentic the user and to create additional security.

A direct connection (as illustrated) or a shielded cable 12 may connect the eyewear 4 to noise cancelling headphones 2, with the shielded cable 12 providing RFI and EMI shielding. The cable wiring may integrate the eyewear to headphones to the mouthpiece. A shielded cable 12 may connect the headphones 2 to the mouthpiece 3 providing RFI and EMI shielding. In some embodiments, the shielded cable 12 may be a USB protocol cable supporting USB interfaces between the headphones 2 and a microphone within the mouthpiece 3.

The headphones 2 may be noise cancelling headphones using any advanced technology to include anti-phase or active noise cancelling technology to cancel out the noise to create complete sound privacy headphones. The headphones may be made of a soundproof padding which fully covers the ears ensuring a secure seal or alternate technology which enables soundproofing. The headphones 2 may allow the user to hear information from a presentation, conference, or any audio connected to the integrated system, while preventing others from overhearing the audio.

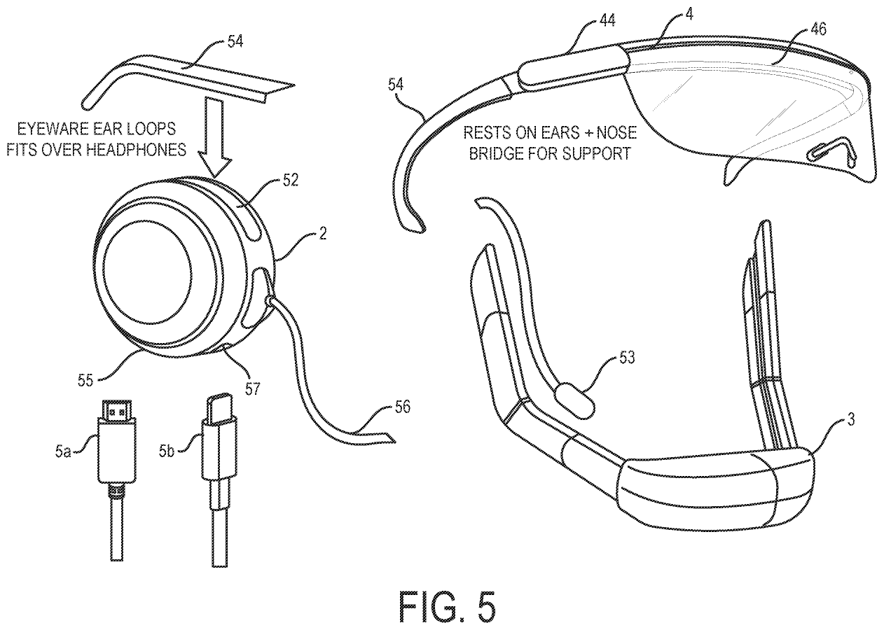

A sound canceling mouthpiece 3 may be coupled to or integrated in the headset 1, the eyewear 4 and/or the headphones 2: The purpose of the mouthpiece 3 is to make speech confidential and private. The mouthpiece 3 may be integrated to the headphones 2 allowing what is being spoken to be clearly heard. The mouthpiece 3 may include a microphone or unaided augmentative/alternative communications built into a soundproof padded enclosure that covers the mouth. An example of a microphone 53 is illustrated in FIG. 5. The communication built into a soundproof padded enclosure covering the mouth may allow for better capturing of speech by a microphone to support speech to text software. The soundproof padding in the mouthpiece 3 may ensure that the speech remains confidential by preventing the user's speech from being overheard by others. The mouthpiece 3 may be hands-free ensuring a tight seal around the mouth to prevent the user's voice from being heard.

Upon connecting the headset 1 (and/or the headphones 2, shielded mouthpiece 3 and/or eyewear 4) to a mobile device or desktop computer, the display of information and sound generated by the mobile device or desktop computer maybe shifted to the eyewear 4 and the headphones 2, and audio input shifted to the shielded microphone within the mouthpiece 3. While the mobile device or desktop may run the desired software (e.g. Citrix®) the eyewear 4 may replace the use of the device screen and the headphones may replace the device audio.

To protect information and create a virtual operating system, the mobile device or desktop, while connected to the headset 1, may securely access all sanctioned applications through an end-to-end encrypted and decryption capability, which could be hosted on a secure cloud or a data center. The integrated system may access a virtual operating system ensuring that all the data and information are never stored or retained on the mobile device or desktop, but rather retained on a secure cloud or in a data center that can be monitored and controlled.

The mouth piece 3 may include sound shielding to muffle the sound of the user's voice. The mouth piece 3 may include a mute/unmute button 13 that enables the user to toggle between muting and unmuting a microphone within the mouthpiece 3. In some embodiments, the mouthpiece 3 may include a capability to generate masking sounds that may be emitted by a speaker 14 to mask the sound of the user's voice, further preventing anyone from eavesdropping on the user's words. The masking sounds may emanate from the speaker 14 to create a white noise like sound. The external masking capability (e.g. white noise) may be controllable to provide the user various volume levels through a white noise control interface 15. The external masking capability may not be detected by the microphone inside the mouthpiece 3.

In order to create an end-to-end encrypted capability, the virtual operating system (e.g. Citrix®) and the headset 1 should authenticate each other. Any suitable end to end method can be used to provide encryption and decryption to support an end-to-end secure link via a mobile device or desktop computer to the virtual operating system. In order to establish two factor authentication of the user, the headset may include sensors configured to support biometric authentication of the user, such as obtaining a retinal scan, finger print, and/or voice print. To provide further security of confidential information, the headset 1 may also include contact sensors 9 configured to detect when the headset is positioned on the user's head to ensure continued contact of the headset 1 with the user. If the headset 1 does not maintain proper contact with the head of the user, this will be detected by the contact sensors 9 and the authentication (hand shake) between the headset 1 and the virtual operating system providing visual display or audio or voice access will be broken.

The eyewear 4 may be worn like glasses or goggles that wrap around the ear with the noise cancelling headphones. From the headphones 2 there may be a wired connection 12 (e.g., a USB cable) to the hands-free mouthpiece 3. The three elements of the headphones 2, mouthpiece 3 and eyewear 4 may be fully integrated and interconnected within the headset 1. Upon turning on the headset 1 and connecting it to a mobile device or desktop dear, the three elements (eyewear 4, headphones 2, and mouthpiece 3) may initiate a virtual visual display, and private and secure hearing and voice capability.

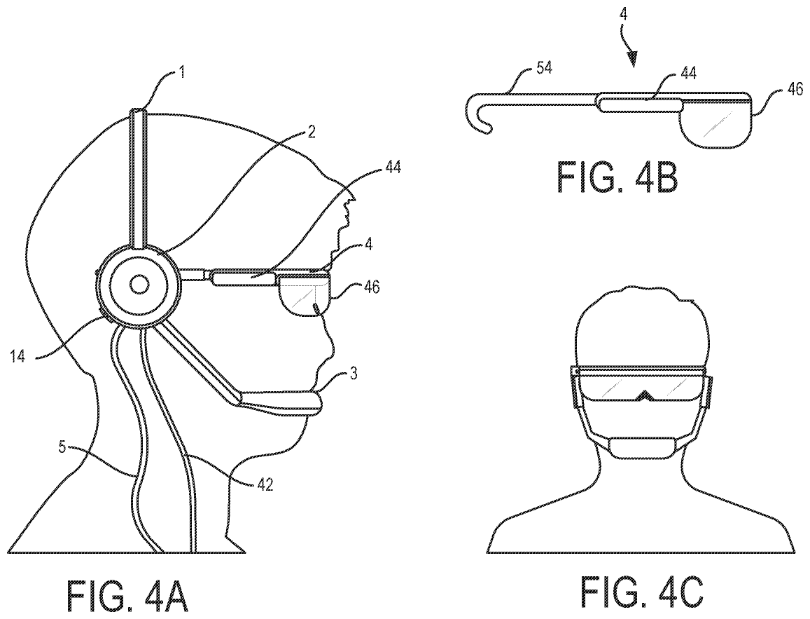

The eyewear 4 may include an image projector and lenses (e.g., illustrated in FIG. 4) that have a one way privacy film that lets the user you a projected image while seeing through the glasses so that the user can use a keyboard or mouse while operating the headset 1.

Device Application Setup: The first time this headset 1 (and/or the headphones 2, shielded microphone 3 and/or eyewear 4) is connected to a mobile device or desktop it may need to be registered. During the registration process the user may be prompted to register their retina and thumbprint via a biometric scanner 7, which can be used for using biometric information for multi-factor authentication (MFA). This may be a onetime setup for a user and after this is complete it is ready for usage.

Device Usage process flow: The user connects the headset 1 (and/or the headphones 2, shielded microphone 3 and/or eyewear 4) using a secure wired or wireless connection to a mobile device or desktop and turns on the headset 1. When a user connects to a secure network, the user may be prompted to enter login credentials. After the user has entered login credentials, the user may be prompted to wear the eyewear 4. After the user has put on the eyewear 4 an application may prompt the user to start a retinal can and/or a thumbprint scan for multifactor authentication using a biometric scanner 7 or a retinal scanner positioned within the eyewear 4. On successful authentication of the user and the headset 1, the screen and audio of the connected mobile device or desktop computer may be disabled and turned off, and all video may be routed to the eyewear 4, all voice or sound may be routed to the headphones 2, and audio input may only come from the mouthpiece 3. At any point during usage of the headset 1 that the contact sensors 9 indicate that the headset 1 is no longer on the user's head or become disabled, the secure connection to the mobile device or desktop computer will be automatically disconnected and the information and audio will no longer be visible or heard via the headphones 2 and eyewear 4, thereby preventing any data leakage or eavesdropping.

The integrated mobile confidential and secure communication environment may also provide logs of all actions and changes done by the user for audit and tracking. Such logs may be stored within internal memory and/or may be communicated to a mobile device or desktop computer via a secure wired or wireless communication link.

To control volume through the headphones 2, the user may touch volume up/down buttons 10, such as positioned on a support aim of the eyewear 4. Further, the headset 1 may include other user interfaces or buttons 11 for controlling the display or other functions. Additional user interfaces (e.g., buttons, dials, lights, displays, speakers, etc.) may be associated with further functionalities, such as mute, power on/off, battery charging, battery charge state, minimal central processor unit (CPU) required to store and share information, white noise, voice detection, and voice alternating capability. For example, the integrated mobile confidential and secure communication environment may include color coded lights configured to show that the device is properly integrated and connected to the user's electronic device.

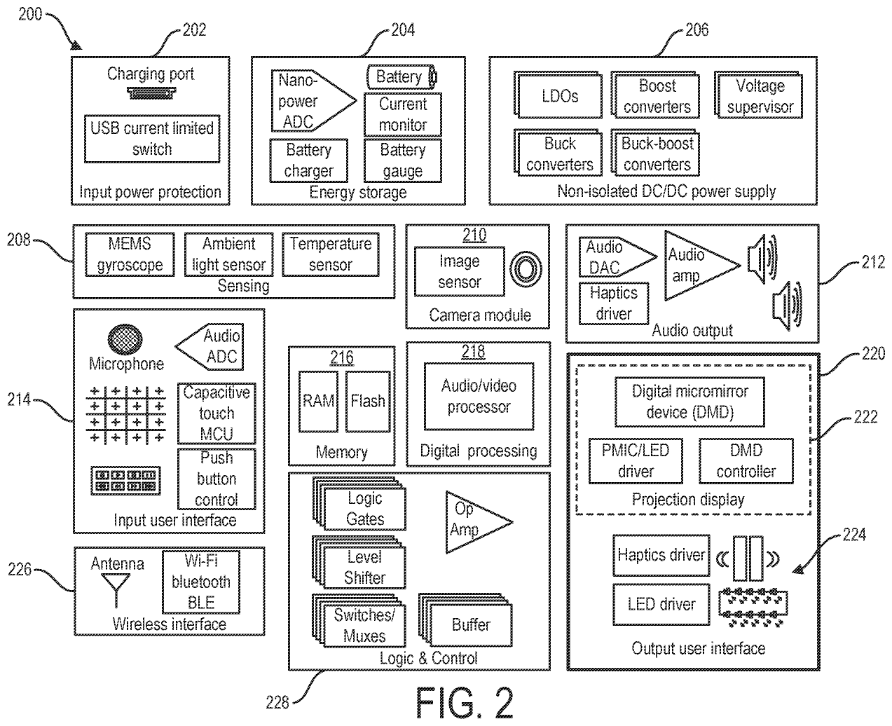

FIG. 2 is a functional block diagram illustrating examples of software modules, functionality and software subsystems that may be configured to perform as an integral software platform 200 executes in one or more processors to provide the functionality supporting an integrated mobile confidential and secure communication environment according to various embodiments. Such software modules, functionality and software subsystems may be implemented within and executed by one or more processors (not shown separately) integrated within one or more components within the headset 1, headphones 2, mouth piece 3 and/or the eyewear 4. For example, one or more processors of an integrated mobile confidential and secure communication environment may execute software modules including one or more of: an input power protection module 202; and energy storage control module 204; a non-isolated DC/DC power supply control module 206; a sensor monitoring and control module 208; a camera control and processing module 210; and audio processing and output module 212; and a user input interface module 214; memory 216; digital processing 218; a user output interface module 220, which may include a control module four projection display 222 and output controllers 224; a wireless interface control module 226; and/or various logic and control modules 228. FIG. 2 illustrates nonlimiting examples of different components and software elements/functionality that may be included in each of these example software modules. Various embodiments many have other (additional) or fewer software modules, functionality and software subsystems.

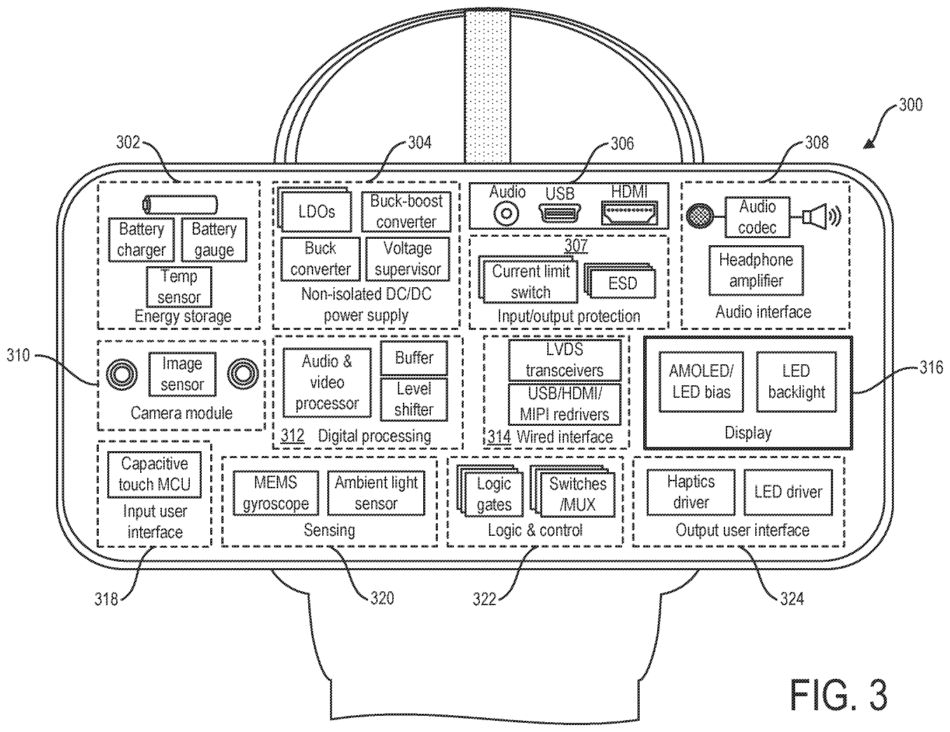

FIG. 3 is a hardware block diagram illustrating examples of hardware components and subsystems that may be coupled or integrated together, such as within the headset 1, to provide the functionality to support an integrated mobile confidential and secure communication environment according to various embodiments. Such components and subsystems may be integrated within or coupled to the headset 1, headphones 2, mouth piece 3 and/or the eyewear 4. For example, an integrated mobile confidential and secure communication environment may include one or more of: an energy storage subsystem 302 (e.g., a battery, battery charger, battery gauge and temperature sensor); a non-isolated DC/DC power supply 304; input/output interfaces 306; input/output protection circuits 307; audio interface circuitry (e.g., audio codec, headphone amplifier, etc.); a camera module 310 (e.g., including an image sensor or camera); one or more digital processing units 314; a display and display complements 316; one or more user input interfaces 318; various sensors 320 (e.g., gyroscopes, accelerometers, light sensors, etc.); various logic and control modules 322 and/or one or more user output interfaces 324. In various embodiments, the hardware components and subsystems may be implemented in one or more integrated circuits, one or more system-on-chip devices, and/or one or more circuit boards. Also, the various components may be packaged within a shielded housing and/or connected via shielded cables so as to minimize or prevent leakage of electromagnetic signals. Various embodiments many include other (additional) or fewer hardware components and subsystems.

FIGS. 4A-4C are diagrams illustrating major components of a first alternative example embodiment. In this illustrated embodiment, the headphones 2 and mouth piece 3 are integrated together in a headset 1 with the eyewear 4 configured as a separate unit as illustrated in FIG. 4B. The eyewear 4 may include an image projector 44 positioned and configured to project images on the lenses 46 in a manner that can be viewed by the user. As noted above, the lenses 46 may include a surface coating that enables the user to view projected images while looking through the lenses, such as to view a keyboard, an object being worked on, or objects in the distance (e.g., the roadway while operating a vehicle). In some embodiments, such a surface coating may also prevent the images from being viewed from the outside by others. As nonlimiting examples, the image projector 44 may be the same as or similar to image projectors in the Vuzix® smart glasses made by Vuzix Corporation, Iristick® smart glasses manufactured by Iristick NV, or similar commercial products. In the embodiment illustrated in FIG. 4, power may be provided to the headset 1 via a separate charging cable 42.

FIG. 5 is a diagram illustrating selected components of the first alternative example embodiment. As shown in this figure, the eyewear 4 ear temples 54 may fit into a groove 52 within the headphones 2. Such groove may include electrical contacts to provide a secure data communication interface between circuitry in the eyewear 4 (e.g., the image projector 44) and circuitry in the headphones 2. For example, the electrical contacts within the groove 52 may include contacts for a VGA, HTML or other video cable to support transmission of image data to the projector 44.

FIG. 5 also illustrates an example of how a microphone 53 may be positioned within the mouthpiece 3, with the mouthpiece 3 serving to block the sound of the user's voice from being overheard by others. In some embodiments, the microphone 53 may be coupled via a USB cable 56 to circuitry within the headphones 2.

FIG. 5 also illustrates examples of cables providing connections to a smart phone or desktop computer, which may include an HDMI cable 5a that connects to an HDMI socket 55 in the headphones 2, and/or a USB-C cable 5b that connects to a USB-C socket 57 in the headphones 2.

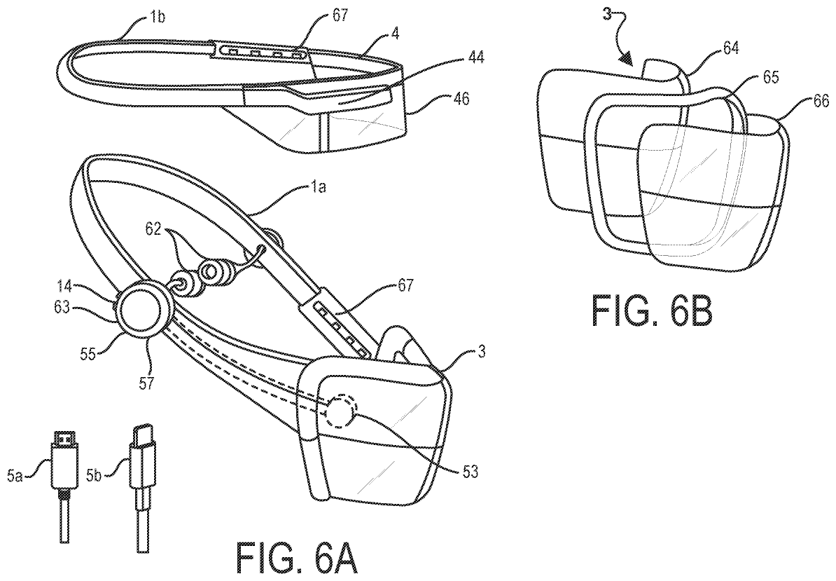

FIG. 6 is a diagram illustrating major components of a second alternative example embodiment. As shown in FIG. 6, the headphones 2 may be replaced with earbuds 62, which may be coupled to a control unit 65 that may include the cable interfaces (e.g., HDMI, USB and/or other input/output interfaces). This figure also illustrates a microphone 53 within the mouthpiece 3, as well as the eyewear 4 configured as a separate component. Such embodiments in which the eyewear 4 is configured as a separate unit, communications between the eyewear 4 and the control unit 65 may be via a wireless communication link (e.g., Wi-Fi, Bluetooth, etc.) over which image data is communicated. Such embodiments may be appropriate in circumstances in which electronic eavesdropping of image data is not of concern or a realistic risk. In some embodiments, an optional shielded cable (not shown) may be provided for connecting the eyewear 4 to the control unit 65 when there is a risk of electronic eavesdropping of image data.

FIG. 6A is a diagram illustrating major components of a second alternative example embodiment. As shown in FIG. 6, the headphones 2 may be replaced with earbuds 62, which may be coupled to a control unit 63 that may include the cable interfaces 55, 57 or connecting to a cable (e.g., HDMI 5a, USB-C 5b, etc.) for connecting to a smart phone or desktop computer. In this embodiment, the eyewear 4 may be a separate unit from the earbuds 62, control unit 63 and mouthpiece 3. For example, the earbuds 62, control unit 63 and mouthpiece 3, including a microphone 53 within the mouthpiece, may be supported on the user's head by a first strap 1a, while the eyewear 4 is supported on the user's head by the second head strap 1b. The second head strap 1b supporting the eyewear 4 may include a length adjustment structure 67 that enables a user to adjust the band to fit the user's head.

In embodiments such as illustrated in FIG. 6A in which the eyewear 4 is configured as a separate unit, communications image data from the control unit 65 to the eyewear 4, and optionally eye tracking or iris scan data from sensors within the eyewear 4 to the control unit 65, may be accomplished via a wireless communication link (e.g., Wi-Fi, Bluetooth, etc.). Such embodiments may be appropriate in circumstances in which electronic eavesdropping of image data is not of concern or a realistic risk. In some embodiments, an optional shielded cable (e.g., HDMI or USB-C not shown) may be provided for connecting the eyewear 4 to the control unit 65 when there is a risk of electronic eavesdropping of image data.

FIG. 6B illustrates details of an embodiment for the mouthpiece 3 to provide sound buffering to prevent or limit eavesdropping of user's voice. Example, similar to soundproof window technology, the mouthpiece may include a first panel 64 of a sound buffering polymer membrane, and a second panel 66 of a sound buffering polymer membrane (either the same type of polymer or a different polymer than the first panel 64), with the two panels separated by an edge seal 65, thereby forming a gap between the first panel 64 and the second panel 66.

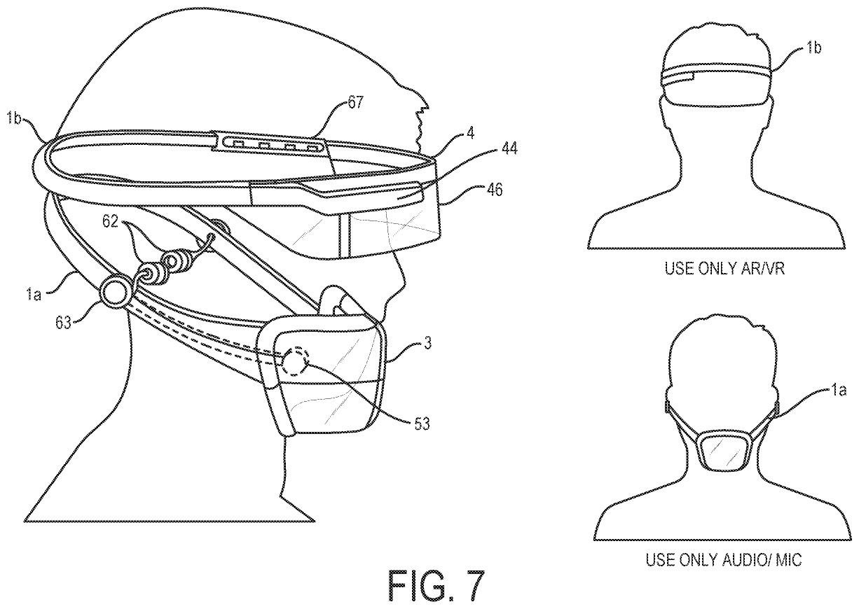

FIG. 7 is a diagram illustrating the embodiment illustrated in FIG. 6A while being worn by a user. In particular, FIG. 7 illustrates that in some circumstances, a user may only wear the audio assembly, including the earbuds 62, mouthpiece 3 and microphone 53, such as when a voice call is going to be conducted without any video. Also, FIG. 7 illustrates that a user may only wear the eyewear 4, such as when a communication is only going to involve visual information.

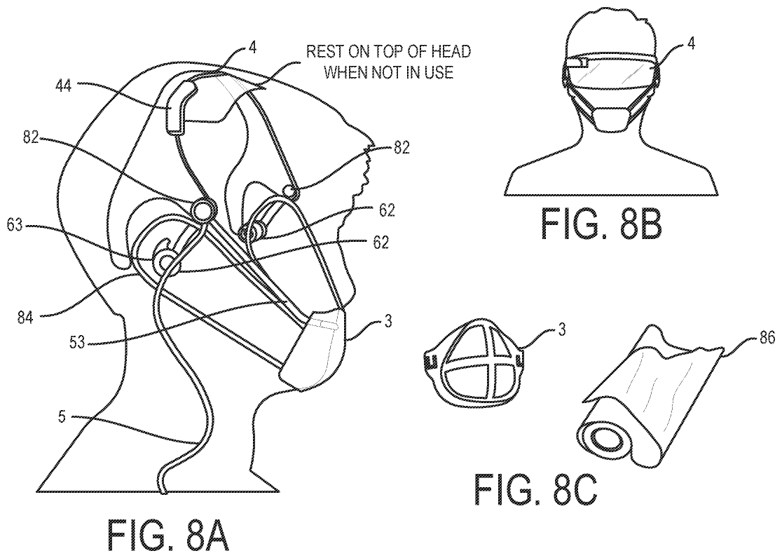

FIG. 8A is a diagram illustrating major components of a third alternative example embodiment. In the embodiment shown in FIG. 8A, the headset 1 integrates the audio output in the form of earbuds 62 with the eyewear 4 as a single unit, while the mouthpiece 3 is configured as a removable mask with your straps 84 that can be placed over the user's ears. In this embodiment, the eyewear 4 is configured with a pivot 82 on the control unit 63 that enables the eyewear 4 to be rotated up to rest on the user's head when not in use as illustrated in FIG. 8A. This position of the eyewear 4 may be preferred by a user when no visual content is being shared. The eyewear 4 may be rotated down over the eyes as illustrated in FIG. 8B when visual information is going to be presented to the user.

FIG. 8C illustrates an embodiment of the mouthpiece 3 in which the mouthpiece provides an internal structural frame on or within which vinyl sound absorbing material 86 may be placed when in use. The use of vinyl sound absorbing material is placed within a mask internal structural frame may provide hygiene benefits as the material can be replaced after each use.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Any reference to claim elements in the singular, for example, using the articles “a,” “an,” or “the” is not to be construed as limiting the element to the singular.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A mobile confidential and secure communication environment, comprising:
a headset configured to be worn by a user;
eyewear coupled to the headset, wherein the eyewear comprises a display that is configured to display images for viewing by the user while preventing such imagery to be viewed by others;
headphones coupled to the headset and configured to provide audio to the user while preventing sounds from being overheard by other;
a mouthpiece including a microphone configured to receive speech spoken by the user while preventing such speech from being overheard by others; and
a secure communication interface configured to provide a secure communication link to a mobile device or desktop computer for communicating sound data to the headphones and sound data from the mouthpiece and communicating image data to the eyewear.

2. The mobile confidential and secure communication environment of claim 1, further comprising a speaker configured to emit noise to mask sounds of user's voice.

3. The mobile confidential and secure communication environment of claim 1, wherein the display in the eyewear comprises an image projector configured to project images on lenses of the eyewear suitable for viewing by the user.

4. The mobile confidential and secure communication environment of claim 1, wherein:
the eyewear is separable from the headphones;
the headphones include slots into which temples of the eyewear can fit when both are worn by a user;
the slots include electrical contacts coupled to circuitry within the headphones; and
the temples of the eyewear include electrical contacts configured to make electrical connections with the electrical contacts in the slot when the temples are positioned in the slots.

5. The mobile confidential and secure communication environment of claim 1, further comprising a control unit providing the secure communication interface, wherein the headphones are earbuds coupled to the control unit.

6. The mobile confidential and secure communication environment of claim 5, further comprising a hinge coupling the eyewear to the control unit, the hinge configured to enable the eyewear to be rotated to rest on the user's head when not in use.
